(19) United States
(12) Patent Application Publication
(10) Pub. No.: US 2005/0160267 A1
(43) Pub. Date: Jul. 21, 2005

(54) Printer capable of securing a print job and a method thereof

(75) Inventor: Song-Baik Jin, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/036,365

(22) Filed: Jan. 18, 2005

(30) Foreign Application Priority Data
Jan. 20, 2004 (KR) 2004-4266

(51) Int. Cl. H04L 9/00

(52) U.S. Cl. 713/168

(57) ABSTRACT

A printer for securing a print job and a method thereof is disclosed. The printer includes an authorization key generation part for generating an authorization key of an external device; an encoding part for receiving data from the external device and encoding the received data; a transmitting part for transmitting the encoded data and the authorization key to the external device in order to update the data stored in the external device; and a printing part for decoding the encoded data and printing the decoded data when a request for printing the updated data is received and the updated authorization key of the data matches the authorization key generated by the authorization key generation part. Accordingly, data stored in the external device can be printed by using a predetermined printer selected by a user or a printer that encoded the data.

### CROSS-REFERENCE TO RELATED APPLICATIONS

This application claims the benefit under 35 U.S.C. 119(a) of Korean Patent Application No. 2004-4266, filed on Jan. 20, 2004, in the Korean Intellectual Property Office, the entire contents of which are incorporated herein by reference.

### BACKGROUND OF THE INVENTION

1. Field of the Invention

The present invention relates to a printer capable of securing a print job and a method thereof. More particularly, the present invention relates to a printer and method for preventing the unauthorized printing of data obtained from an external device such as a digital camera, a digital camcorder and a mobile phone and a method thereof.

2. Description of the Related Art

Digital devices such as cameras, camcorders, mobile phones, and personal digital assistants (PDAs) have been reduced in size and weight due to improvements in technology. In addition, the price of these digital devices has been reduced, contributing to the popularity of these devices.

Among these digital devices, a digital camera, a digital camcorder, a mobile phone equipped with a digital camera, a personal digital assistant (PDA) equipped with a miniaturized camera and a digital television can photograph a still image or a moving picture and/or reproduce the still image or the moving picture. Furthermore, the above-mentioned digital devices can transmit the still image or the moving picture to other digital devices. A digital device capable of photographing/reproducing the still image and the moving pictures is often referred to as a digital photographing or recording device.

The still images and the moving picture taken by the digital photographing device can be edited by a computer and predetermined still images from among the edited still images or moving pictures can be printed. As mentioned above, a system for editing the still image and the moving picture, and printing the edited images is called a digital image printing system.

FIG. 1 is a diagram illustrating a conventional digital image printing system.

Referring to FIG. 1, a mobile phone 10, a digital camera 20, or a digital camcorder 30 are connected to a printer 50 through a universal serial bus (USB) (not shown). The mobile phone 10 is equipped with a miniaturized camera for photographing the still image and the moving picture. Also, the printer 50 includes a memory drive (not shown) for reading data from a memory card 40. That is, the memory card 40 can be inserted in the memory drive of the printer 50 and the printer 50 can print an image read from the memory card 40 via the memory drive.

The mobile phone 10, the digital camera 20 or the digital camcorder 30 transmits a predetermined frame of images from among the photographed still images or moving pictures to the printer 50 through the USB cable. Also, the photographed still images and moving pictures can be stored in the memory card 40 by attaching the memory card 40 to the mobile phone 10, the digital camera 20, or the digital camcorder. The memory card 40 can be detached from the mobile phone 10, the digital camera 20, or the digital camcorder, and then the memory card 40 can be attached to the printer 50 for printing the stored still images and moving pictures by reading the still images and moving picture from the memory card 40.

In the digital photographing devices 10, 20, 30, a driver is installed for interacting with the printer 50, where the driver is a software program that controls operations of the digital photographing devices for interaction with the printer 50. The driver also converts a predetermined frame of the still images or the moving pictures taken by the digital photographing devices into a data format of a printer command language (PCL) or a postscript (PS). The PCL and the PS are well-known languages recognized by the printer 50. After converting the predetermined frame, the driver transmits the converted frame to the printer 50.

The printer 50 receives the frame from the digital photographing devices 10, 20, 30 or the memory card 40, and the printer 50 converts the received frame according to a bitmap conversion or a vector conversion.

Finally, the printer 50 prints the frame of still images and the moving picture taken by the digital photographing devices 10, 20, 30 after performing the above mentioned procedures.

However, there is no method provided for preventing unauthorized printing of an image. That is, the conventional digital image printing system prints still images and moving pictures captured by the digital photographing devices without any restrictions, if the driver is installed in the digital photographing devices.

### SUMMARY OF THE INVENTION

Accordingly, the present invention has been made to solve the above-mentioned and/or problems, and an aspect of the present invention is to provide a printer which is capable of preventing unauthorized printing of data obtained from an external device.

In accordance with an aspect of the present invention, there is provided a printer for securing a print job. The printer includes an authorization key generation part for generating an authorization key of an external device, an encoding part for receiving data from the external device and encoding the received data, a transmitting part for transmitting the encoded data and the authorization key to the external device in order to update the data stored in the external device, and a printing part for decoding the encoded data and printing the decoded data when a request for printing the updated data is received and the updated authorization key of the data is matched with the authorization key generated by the authorization key generation part.

The authorization key generation part may include an information storing part for storing information of the printer including a name of a manufacturer of the printer, a device ID and a serial number; and an information receiving part for receiving information of the external device including a name of the manufacturer of the external device, a device ID and a serial number. The authorization key generation part combines the information of the information storing part with the information received at the information receiving unit to generate the authorization key.

The external device may include at least one of a mobile phone having a function for photographing a still image, a digital camera, a digital camcorder and a memory card storing photographed still images.

The encoding part may encode a file selected by a user from among data received from the external device.

It is another aspect of the present invention to provide a method for securing a print job. The method including (a) receiving data from the external device and encoding the received data, (b) generating a first authorization key of the external device, (c) updating the data stored in the external device by transmitting the first authorization key and the encoded data to the external device, (d) generating a second authorization key of the external device when a request for printing the updated data is received, and (e) decoding the updated data when the first authorization key and the second authorization key are identical, and printing the decoded data.

The method may further include (f) storing information of the printer including a name of a manufacturer of the printer, a device ID and a serial number, and (g) receiving information of the external device including a name of a manufacturer of the external device, a device ID and a serial number. The first authorization key and the second authorization key may be generated in steps (b) and (d) by combining information stored in the step (f) and information received in the step (g).

The first and the second authorization keys may be generated by combining a printer information including a manufacturer, a device ID and a serial number, with an external device information including a manufacturer, a device ID and a serial number.

The combining includes performing one of logical operations XOR, OR, AND, NAND, and NOR.

The external device includes at least one of a mobile phone having a function for photographing a still image, a digital camera, a digital camcorder and a memory storing photographed still images.

In the step a), encoding is performed on a file selected by a user from among data received from the external device.

### BRIEF DESCRIPTION OF THE DRAWINGS

The above aspects and features of the present invention will be more apparent by describing certain embodiments of the present invention with reference to the accompanying drawings, in which:

FIG. 1 is a view illustrating a conventional digital image printing system;

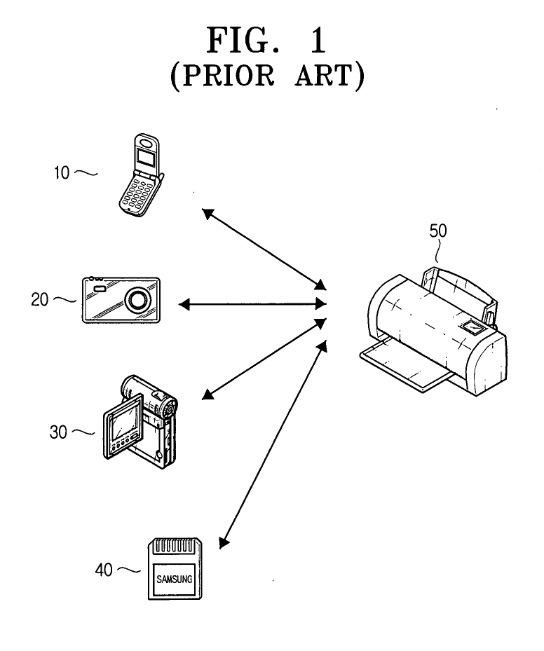

FIG. 2 is a diagram illustrating a printer capable of securing a printing job in accordance with an embodiment of the present invention;

FIG. 3 is a flowchart illustrating a method for securing a print job in accordance with an embodiment of the present invention; and

FIG. 4 is a table illustrating an example of an authorization key in FIG. 2 in accordance with an embodiment of the present invention.

### DETAILED DESCRIPTION OF THE PREFERRED EMBODIMENTS

Certain embodiments of the present invention will be described in greater detail with reference to the accompanying drawings.

In the following description, the same drawing reference numerals are used for the same elements throughout the drawings. The matters defined in the description such as a detailed construction and elements are exemplary. Thus, it should be apparent that the present invention is not limited to those examples. Also, well-known functions or constructions are not described for conciseness.

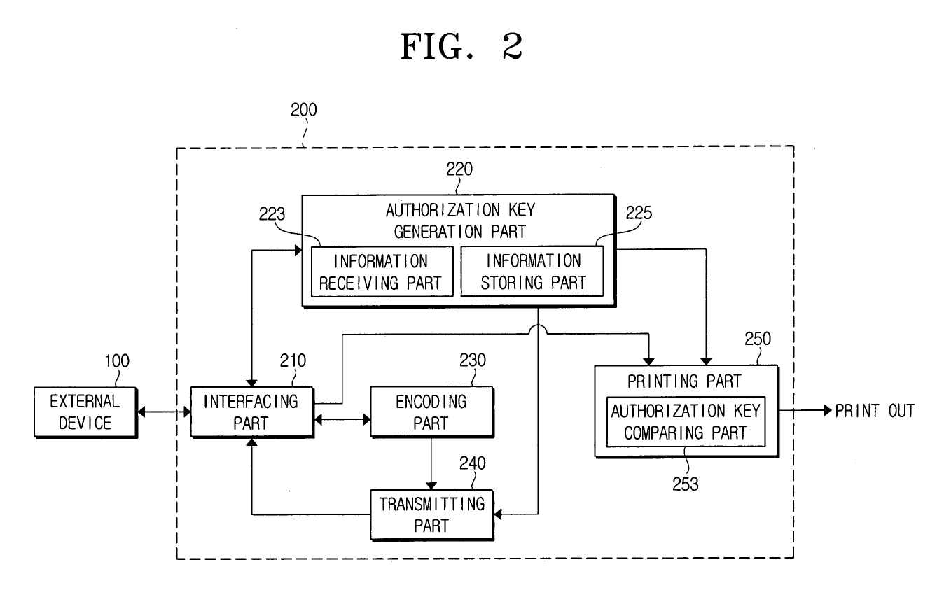

FIG. 2 is a diagram illustrating a printer capable of securing a print job in accordance with an embodiment of the present invention. As shown in FIG. 2, the printer 200 includes an interfacing part 210, an authorization key generation part 220, an encoding part 230, a transmitting part 240 and a printing part 250. The authorization key generation part 220 further includes an information receiving part 223 and an information storing part 225. Also, the printing part 250 includes an authorization key comparing part 253.

The interfacing part 210 is connected to an external device 100. The external device 100 may be a computer having an application program that produces and edits images or documents, a digital image photographing device such as a digital camera, a digital camcorder and a mobile phone equipped with a miniaturized camera or a memory card for storing still images and moving pictures taken by the digital photographing device. The interfacing part 210 includes a memory card slot (not shown) for receiving the memory card which is attachable to the memory card slot. The memory card stores still images and moving pictures taken by a digital image photographing device. A driver (not shown) may be installed in the printer for recognizing the type of digital image photographing device when the digital image photographing device is connected to the printer.

The authorization key generation part 220 generates a first authorization key of the external device 100 which is connected through the interfacing part 210. As mentioned above, the authorization key generation part 220 includes the information receiving part 223 and the information storing part 225. The information receiving part 223 receives information about the external device 100 including a name of a manufacturer of the external device 100, a device ID and a serial number. Also, the information storing part 225 stores information about the printer 200 including a name of the manufacturer of the printer 200, the device ID and the serial number.

The authorization key generation part 220 generates the first authorization key by combining the information of the printer 200 and the information of the external device 100. The authorization key generation part 220 may combine the information of the printer 200 and the information of the external device 100 by using one of the following logical operations such as XOR, OR, AND, NAND and NOR for generating the first authorization key. However, a method for generation of the first authorization key is not limited to use of logical operations such as XOR, OR, AND, NAND and NOR. Any other method can be used for generating the first authorization key.

The encoding part 230 receives data for printing from the external device 100 and encodes the received data. Also, the encoding part 230 stores the encoded data. In one embodiment of the present invention, the encoding part 230 encodes the data received from the external device. However, the encoding part 230 may be implemented to select a predetermined file from among data stored in the external device and encode the selected file. That is, the encoding part 230 may be implemented to display on a display screen (not shown) a message requesting whether to encode data from the external device 100 and then the encoding part 230 may display a selection menu for selecting a predetermined file to display (not shown) when the request for encoding is accepted. Accordingly, the encoding part 230 may encode the predetermined file selected by a user.

The transmitting part 240 transmits the first authorization key and the encoded data to the external device 100 through the interfacing part 210 in order to update the data stored in the external device 100.

Meanwhile, if a request for printing the updated data is received, the authorization key generation part 220 generates a second authorization key for the external device 100 that is storing the updated data such as a digital photographing device or the memory card.

The authorization key comparing part 253 of the printing part 250 compares the first authorization key updated by the transmitting part 240 and stored in the external device 100 with the second authorization key generated by the authorization key generation part 220.

The printing part 250 decodes the data received from the external device 100 through the interfacing part 210 and prints the decoded data if the first authorization key and the second authorization key match. That is, if the updated data is encoded and stored on the external device 100, the updated data that is encoded can only be printed on printer 200. If printing is attempted on a different printer, the printer would not be able to decode the updated data on the external device 100 because it would not have an authorization key or a matching authorization key.

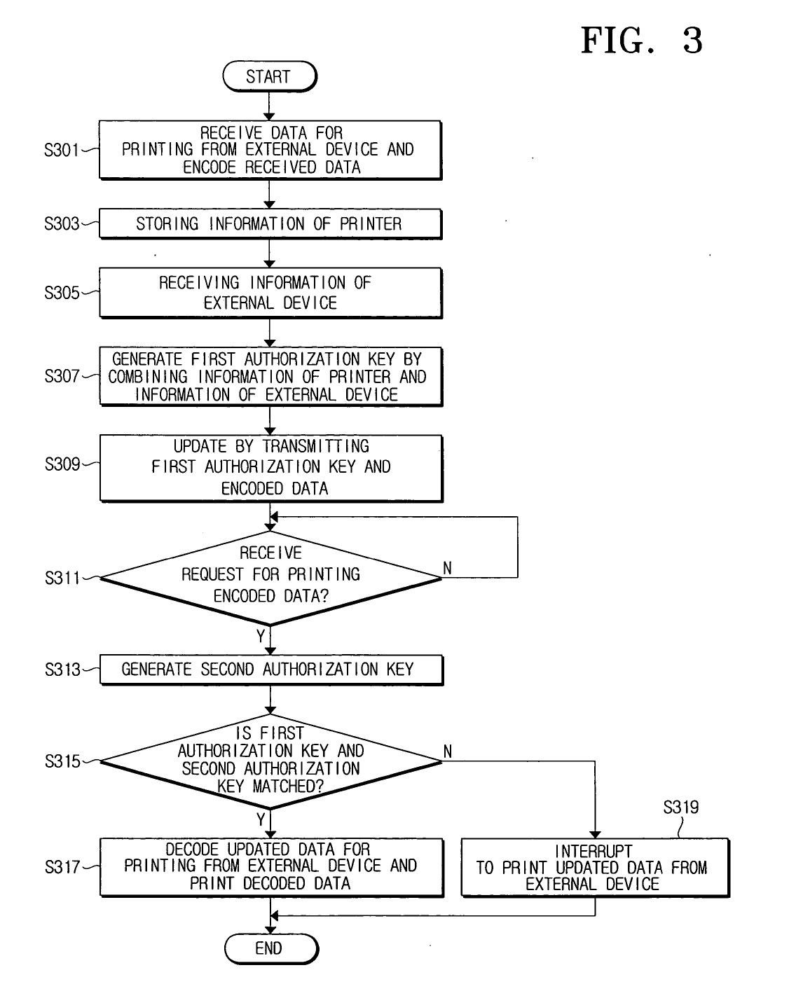

FIG. 3 is a flowchart illustrating a method for securing a print job in accordance with an embodiment of the present invention. By referring to FIGS. 2 and 3, operations of the printer 200 for securing a print job are explained in detail.

When the external device 100 is connected through the interfacing part 210, the encoding part 230 asks a user whether data stored in the external device 100 should be encoded. That is, the encoding part 230 displays a message on a display screen (not shown) asking a user whether data stored in the external device 100 should be encoded. Accordingly, the user can determine whether the data should be encoded.

If the user decides to encode the data stored in the external device 100, the encoding part 230 receives the data from the external device 100 and encodes the received data at step S301.

Meanwhile, the information storing part 225 of the authorization key generation part 220 stores information of the printer 200 including a name of the manufacturer, a device ID and a serial number at step S303. Also, the information receiving part 223 of the authorization key generation part 220 receives information about the external device 100 including a name of the manufacturer, the device ID and the serial number from the external device 100 connected through the interfacing part 210 at step S305.

The authorization key generation part 220 generates a first authorization key by combining the information of the printer 200 stored in the information storing part 225 and the information of the external device 100 received from the external device 100 at step S307.

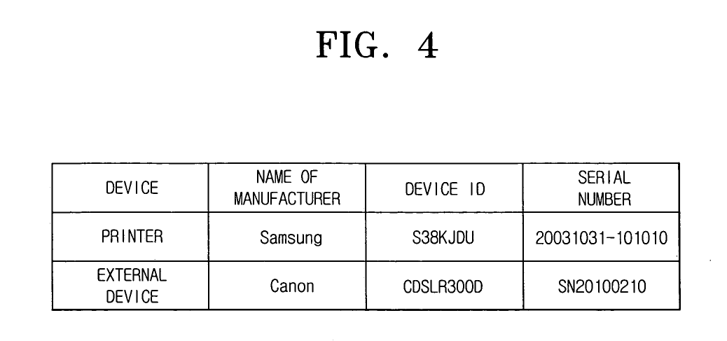

FIG. 4 is a table illustrating an example of an authorization key in FIG. 2. When the information of the printer 200 stored in the information storing part 225 are illustratively Samsung as the manufacturer, S38KJDU as the device ID, and 20031031-101010 as the serial number, and the information of the external device 100 received from the external device 100 are Cannon as the manufacturer, CDSLR300D as the device ID, and SN20100210 as the serial number, the authorization key generation part 220 generates the first authorization key by adding all the information such as SamsungS38JHDY20031031-101010 CannonCDSL300DSN20100210. Also, the authorization key generation part 220 may generate the first authorization key by obtaining information of a predetermined location from the information of the printer and the information of the external device. For example, the first authorization key may be generated by obtaining a first letter of a number in the information of the printer and the information of the external device i.e., SS2CCS. However, a method of generation of the authorization key is not limited to adding all the information or to combining a predetermined position of information. The authorization key may be generated by using various logical operations such as XOR, AND, OR, NOR, NAND or XNOR.

The encoding part 230 may encode the data by combining the data with the generated authorization key. For example, when the data for printing is 1234567890 and the generated authorization key is 369, the data for printing may be encoded by repeatedly adding the generated authorization key to the data for printing as shown in the following equation:
1234567890+369369369=4827150283 Equation 1

The data for printing may be an ASCII value or pixel value of each line, and there is no overflowing between two adjacent digit-numbers during addition. Therefore, when the sum between two adjacent digit numbers exceeds ten, the excess of 10 is ignored. Although addition is used for encoding in the above embodiment, it is not limited to this case only. Accordingly, the authorization key may be generated by various logical operations including XOR, OR, AND, NAND and NOR.

The transmitting part 240 transmits the encoded data and the first authorization key to the external device 100 in order to update the data stored in the external device 100 at step S309.

Meanwhile, when the external device 100 storing the updated data is connected through the interfacing part 210, and a request for printing is received from a user at step S311, the authorization key generation part 220 generates a second authorization key for the external device 100 connected through the interfacing part 210 at step S313. A method for generating the second authorization key is identical to the method for generating the first authorization key. Therefore, a detailed explanation of the method for generating the second authorization key is omitted.

The authorization key comparing part 253 in the printing part 250 compares the first authorization key and the second authorization key at step S315.

If the first authorization key and the second authorization key are identical, the printing part 250 decodes the data for printing received from the external device 100 and prints the decoded data at step S317.

If the first authorization key and the second authorization key do not match, the printing part 250 does not print the updated data from the external device 100 at step S319.

As mentioned above, the printer 200 prints the data stored in the external device only when the first authorization key and the second authorization key match. In contrast, the printer 200 does not print the data stored in the external device when the first authorization key and the second authorization key do not match.

Accordingly, the data can be printed only by using a printer that encodes the data stored in the external device in accordance with an embodiment of the present invention.

Furthermore, the printer of the present invention dose not require prestoring a user ID or a password in order to print data. Therefore, the user can conveniently print data without regard to having a user ID or password.

The foregoing embodiments and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

1. A printer for securing a print job, the printer comprising:
an authorization key generation part for generating an authorization key of an external device;
an encoding part for receiving data from the external device and encoding the received data;
a transmitting part for transmitting the encoded data and the authorization key to the external device in order to update the data stored in the external device; and
a printing part for decoding the encoded data and printing the decoded data when a request for printing the updated data is received and the updated authorization key of the data matches the authorization key generated by the authorization key generation part.

2. The printer of claim 1, wherein the authorization key generation part includes:
an information storing part for storing information of the printer including a name of a manufacturer of the printer, a device ID of the printer and a serial number of the printer; and
an information receiving part for receiving information of the external device including a name of the manufacturer of the external device, the device ID of the external device and the serial number of the external device.

3. The printer of claim 2, wherein the authorization key comprises a combination of the information stored in the information storing part and the information received by the information receiving part.

4. The printer of claim 1, further comprising:
an interfacing part for interfacing the external device with the printer.

5. The printer of claim 4, wherein the interfacing part comprises a slot in the printer.

6. The printer of claim 2, further comprising:
at least one of an XOR gate, OR gate, AND gate, NAND gate and NOR gate for combining the name of the manufacturer of the printer, the device ID of the printer, the serial number of the printer, the name of the manufacturer of the external device, the device ID of the external device and the serial number of the external device.

7. The printer of claim 2, wherein the external device includes at least one of a mobile phone having a function for photographing a still image, a digital camera, a digital camcorder and a memory card storing photographed still images.

8. The printer of claim 7, wherein the encoding part encodes a file selected among data received from the external device by a user.

9. A method for securing a print job, the method comprising the steps of:
(a) receiving data from the external device and encoding the received data;
(b) generating a first authorization key of the external device;
(c) updating the data stored in the external device by transmitting the first authorization key and the encoded data to the external device;
(d) generating a second authorization key of the external device when a request for printing the updated data is received; and
(e) decoding the updated data when the first authorization key and the second authorization key are identical, and printing the decoded data.

10. The method of claim 9, wherein the first and the second authorization keys are generated by combining a printer information including a manufacturer of the printer, a device ID of the printer and a serial number of the printer, with an external device information including the manufacturer of the external device, the device ID of the external device and the serial number of the external device.

11. The method of claim 10, wherein the combining includes one of logical XOR, OR, AND, NAND, and NOR operations.

12. The method of claim 11, wherein the external device includes at least one of a mobile phone having a function for photographing a still image, a digital camera, a digital camcorder and a memory storing photographed still images.

13. The method of claim 11, wherein in the step a), encoding is performed on a file selected by a user from among data received from the external device.

14. The method of claim 8, further comprising:
interfacing the external device with a printer.
